(19) United States
(12) Patent Application Publication
(10) Pub. No.: US 2012/0081282 A1
(43) Pub. Date: Apr. 5, 2012

(54) ACCESS OF AN APPLICATION OF AN ELECTRONIC DEVICE BASED ON A FACIAL GESTURE

(76) Inventor: David H. CHIN, Menlo Park, CA (US)

(21) Appl. No.: 13/324,483

(22) Filed: Dec. 13, 2011

Related U.S. Application Data
(63) Continuation-in-part of application No. 12/122,667, filed on May 17, 2008.
Application No. 12/122,667 is a continuation-in-part of application No. 13/083,632, filed on Apr. 11, 2011.
Application No. 13/083,632 is a continuation-in-part of application No. 13/166,829, filed on Jun. 23, 2011.
Application No. 13/166,829 is a continuation-in-part of application No. 13/189,592, filed on Jul. 25, 2011.

(51) Int. Cl. G09G 5/00

(52) U.S. Cl. 345/156

(57) ABSTRACT

A method of accessing an application of an electronic device based on a facial gesture is disclosed. In one aspect, a method of an electronic device includes capturing an image of a face a user through a camera of the electronic device such that an application of the electronic device is accessible through the electronic device based on the image of the face of the user. The facial gesture of the image of the face of the user of the electronic device is determined to be associated with a user-defined facial gesture. The facial gesture of the image of the face of the user is compared with a designated security facial gesture. An access of the application of the electronic device is permitted when the facial gesture of the image of the face of the user of the electronic device matches the designated security facial gesture.

### CLAIM OF PRIORITY

This application is a continuation-in-part and claims priority from:

1. U.S. application Ser. No. 12/122,667 titled ‘Touch-Based Authentication of a Mobile Device through User Generated Pattern Creation’ filed on May 17, 2008;
2. U.S. application Ser. No. 13/083,632 titled ‘Comparison of an Applied Gesture on a Touchscreen of a Mobile Device with a Remotely Stored Security Gesture’ filed on Apr. 11, 2011;
3. U.S. application Ser. No. 13/166,829 titled ‘Access of an Online Financial Account through an Applied Gesture on a Mobile Device’ filed on Jun. 23, 2011; and
4. U.S. application Ser. No. 13/189,592 titled ‘Gesture Based Authentication for Wireless Payment by a Mobile Electronic Device’ filed on Jul. 25, 2011.

### FIELD OF TECHNOLOGY

This disclosure relates generally to access of an application of an electronic device based on a facial gesture.

### BACKGROUND

A user may need to access an application of an electronic device (for example, a mobile phone, a mobile media player, a tablet computer, an Apple® iPhone®, an Apple® iPad®, a Google® Nexus S®, an HTC® Droid®, etc.). In addition, the user may need to conduct a transaction through the electronic device. The electronic device and/or the application of the electronic device may need a security feature to prevent unauthorized access.

Access of the electronic device and/or an application of the electronic device may require authentication using a personal identification number (PIN) and/or password. Typing in a long string of alphanumeric characters on a miniaturized or virtual keyboard may be slow, inconvenient, and/or cumbersome. A disabled user (for example, a visually impaired person or one with limited dexterity) may have difficulty inputting information on a mobile keypad. A thief may steal the personal identification number and/or password, which may result in a loss of personal information and/or a financial asset of the user of the electronic device.

### SUMMARY

Methods and systems of accessing an application of an electronic device based on a facial gesture are disclosed. In one aspect, a method includes capturing an image of a face a user through a camera of the electronic device such that an application of the electronic device is accessible through the electronic device based on the image of the face of the user. The image of the face of the user may include a facial gesture of the user. A processor of the electronic device determines that the facial gesture of the image of the face of the user of the electronic device is associated with a user-defined facial gesture. The facial gesture of the image of the face of the user of the electronic device is compared with a designated security facial gesture. An access of the application of the electronic device is permitted when the facial gesture of the image of the face of the user of the electronic device matches the designated security facial gesture.

The electronic device may be a mobile device. The method may also include restricting the access of the application of the electronic device when the facial gesture of the image of the face of the user of the electronic device is different than the designated security facial gesture. An identification of the user may be permitted through the electronic device when the facial gesture of the image of the face of the user of the electronic device matches the designated security facial gesture. An authentication of the user may be permitted through the electronic device when the facial gesture of the image of the face of the user of the electronic device matches the designated security facial gesture.

The method may include permitting a transaction of the user through the electronic device when the facial gesture of the image of the face of the user of the electronic device matches the designated security facial gesture. The transaction may be a financial transaction. A financial transaction of the user may be permitted through the electronic device and an initiator device through a Near Field Communication (NFC) system when the facial gesture of the image of the face of the user of the electronic device matches the designated security facial gesture.

The method may include comparing the image of the face of the user of the electronic device with a reference image of the user. The access of the application of the electronic device may be permitted when the facial gesture of the image of the face of the user of the electronic device matches the designated security facial gesture and when the image of the face of the user matches the reference image of the user.

In another aspect, a method of a server device includes determining through a processor that a facial gesture of an image of a face of a user of an electronic device is associated with a user-defined facial gesture. The facial gesture of the image of the face of the user of the electronic device is compared with a designated security facial gesture. An access of an application of the electronic device is permitted when the facial gesture of the image of the face of the user of the electronic device matches the designated security facial gesture.

In yet another aspect, a method of an electronic device includes capturing an image of a face of a user through a camera of the electronic device such that an application of the electronic device is accessible through the electronic device based on the image of the face of the user. A processor compares the image of the face of the user of the electronic device with a reference image of the user. An access of the application of the electronic device is permitted when the image of the face of the user of the electronic device matches the reference image of the user.

The methods, systems, and apparatuses disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

Example embodiments are illustrated by way of example and not limitation in the figures of the accompanying drawings, in which like references indicate similar elements and in which:

FIG. 1A illustrates a system view of an access of an application of an electronic device based on a facial gesture, according to one embodiment.

FIG. 1B illustrates a system view of an access of an application of an electronic device based on a facial gesture through a remote computer server, according to one embodiment.

FIG. 1C illustrates an example of a facial gesture, according to one embodiment.

FIG. 2 is a block diagram illustrating the contents of a facial gesture module and the processes within the facial gesture module, according to one embodiment.

FIG. 3 is a table view illustrating various fields such as an initial state, a facial gesture, a match, and an access, according to one embodiment.

FIG. 4 illustrates a schematic view of the matching of the image of the user and the designated security facial gesture to permit transmission of the protected data from the electronic device to the initiator device, according to one embodiment.

FIG. 5 illustrates a system view of a processing of an image of a face of a user through a facial gesture algorithm, according to one embodiment.

FIG. 6 is a flow chart illustrating accepting and comparing an image of a facial gesture to access an application of the electronic device, according to one embodiment.

FIG. 7 is a diagrammatic view of a data processing system in which any of the embodiments disclosed herein may be performed, according to one embodiment.

Other features of the present embodiments will be apparent from the accompanying drawings and from the detailed description that follows.

### DETAILED DESCRIPTION

Methods and systems of accessing an application of an electronic device based on a facial gesture are disclosed. In the following description of embodiments, reference is made to the accompanying drawings which form a part hereof, and in which it is shown by way of illustration specific embodiments in which the invention can be practiced. It is to be understood that other embodiments can be utilized and structural changes can be made without departing from the scope of the preferred embodiments.

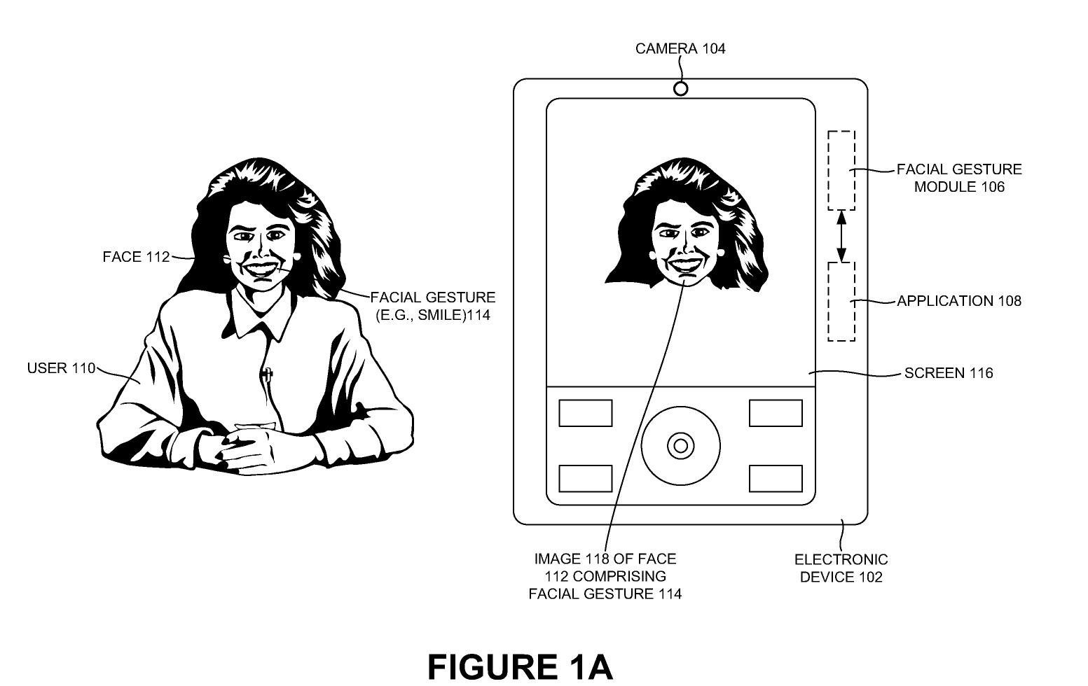

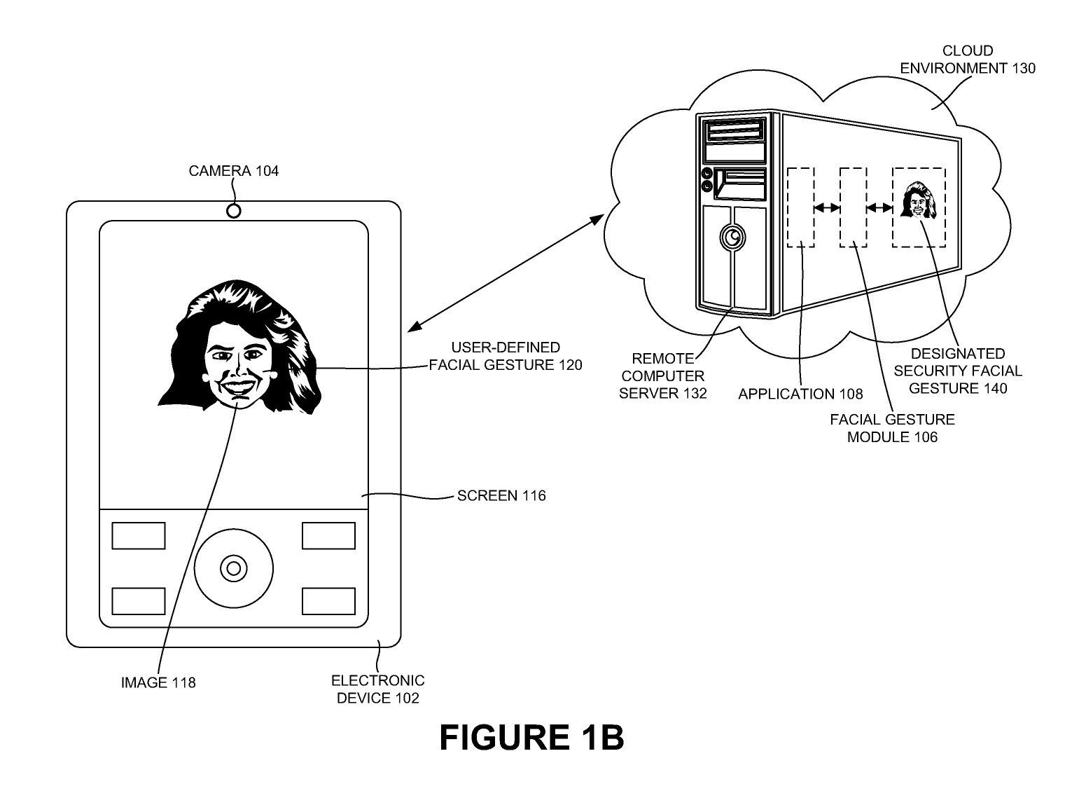

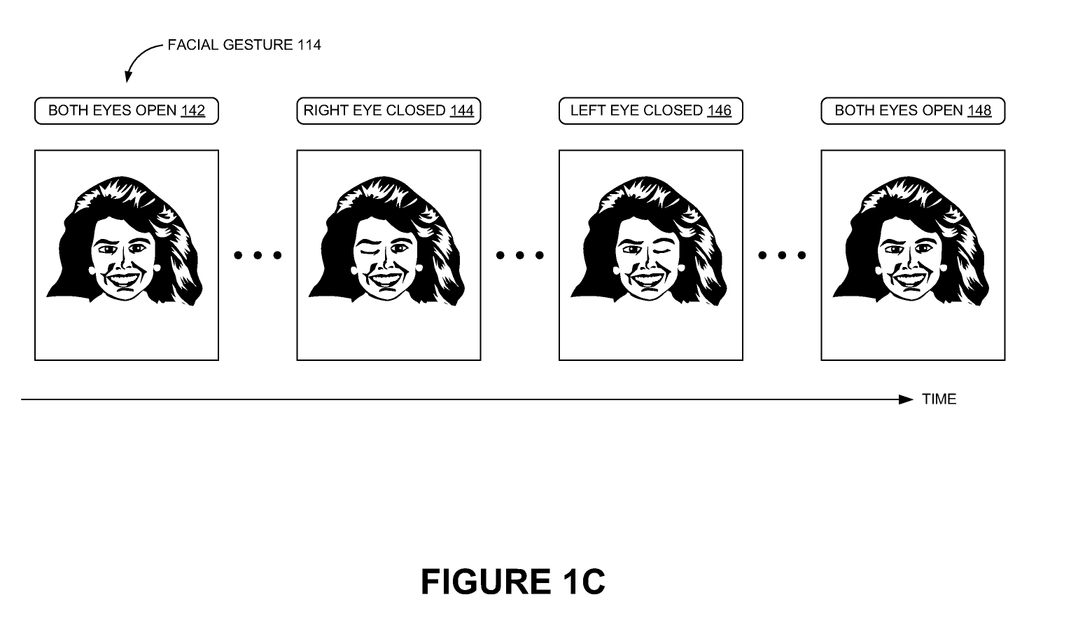

FIG. 1A illustrates a system view of an access of an application 108 of an electronic device 102 based on a facial gesture 114, according to one embodiment. The electronic device 102 may be, for example, a mobile phone or a tablet computer. The electronic device 102 may include a camera 104, a screen 116, an application 108, and a facial gesture module 106.

The user 110 may use the camera 104 of the electronic device 102 to capture an image 118 of the face 112 of the user 110. The user 110 may have a facial gesture 114. A facial gesture 114 may be a facial expression involving a contortion of a human face in a manner that expresses a change in a visual appearance or sentiment associated with a human emotion commonly understood in a cultural norm under which a community of users in a geo-spatial area are statistically likely to commonly recognize as displaying a particular type of human trait whether that trait be one of a winking motion, a kind emotion, an angry emotion, a perplexed emotion, a pontificating emotion, a confused emotion, a happy emotion, a sad emotion, and/or a humorous emotion. The facial gesture 114 may comprise one or more motions and/or positions of the muscles of the face 112. In one embodiment, the facial gesture 114 may be a static gesture, for example, a smile, a frown, a look of surprise, etc. In another embodiment, the facial gesture 114 may be a dynamic gesture, for example, blinking, winking, etc.

In one embodiment, the image 118 of the face 112 comprising the facial gesture 114 may be displayed on the screen 116 of the electronic device 102. In one embodiment, the image 118 may be a static image such that the image 118 captures a static gesture. In another embodiment, the image 118 may be a dynamic image such that the image 118 captures a motion of the face, for example a dynamic gesture.

FIG. 1B illustrates a system view of an access of an application 108 of an electronic device 102 based on a facial gesture 114 through a remote computer server 132, according to one embodiment. The electronic device 102 may access a cloud environment 130 through a network. The cloud environment 130 may be an aggregation of computational resources accessible to the electronic device 102. The cloud environment 130 may comprise a remote computer server 132. The electronic device 102 may communicate with the remote computer server 132 though wireless communications.

The remote computer server 132 may comprise a facial gesture module 106, an application 108, and/or a designated security facial gesture 140. The facial gesture module 106 may determine that the facial gesture 114 of the image 118 of the face 112 of the user 110 of the electronic device 102 is associated with a user-defined facial gesture 120. The user-defined facial gesture 120 may be a facial gesture 114 associated with accessing an application 108. The application 108 may be a software program designed to perform a task. For example, the application 108 may permit a user 110 to access the electronic device 102, email, and/or files.

The facial gesture 114 of the image 118 of the face 112 of the user 110 of the electronic device 102 is compared with a designated security facial gesture 140. An access of the application 108 of the electronic device 102 may be permitted when the facial gesture 114 of the image 118 of the face 112 of the user 110 of the electronic device 102 matches the designated security facial gesture 140. Access of the application 108 of the electronic device 102 may be restricted when the facial gesture 114 of the image 118 of the face 112 of the user 110 of the electronic device 102 is different than the designated security facial gesture 140.

In one embodiment, the facial gesture module 106 may identify the user 110 through the electronic device 102 when the facial gesture 114 of the image 118 of the face 112 of the user 110 of the electronic device 102 matches the designated security facial gesture 140. In another embodiment, the facial gesture module 106 may authenticate the user 110 through the electronic device 102 when the facial gesture 114 of the image 118 of the face 112 of the user 110 of the electronic device 102 matches the designated security facial gesture 140. The authentication of the user 110 may permit the user 110, for example, to access a restricted area, to make a financial transaction, and/or to share personal information.

In another embodiment, multiple resources in a remote computer server 132 may be accessed through a electronic device 102 by accepting a user-defined facial gesture 120 as an input on a electronic device 102, transmitting the user-defined facial gesture 120 to a remote computer server 132, storing the user-defined facial gesture 120 in the remote computer server 132, comparing a facial gesture 114 on the electronic device 102 to the designated security facial gesture 140 stored in the remote computer server 132, sending an authorizing signal to permit an access of an application 108 through the electronic device 102 if the facial gesture 114 capture through the electronic device 102 matches the designated security facial gesture 140. Another embodiment may involve remotely enabling the user 110 to define the designated security facial gesture 140.

An example of a facial gesture 114 may include blinking both eyes twice, followed by transiently raising his left eyebrow, nodding his head once, and then winking his right eye, all performed within a span of one second or less. Another example of a facial gesture 114 may contain a temporal component; for example, it may be composed of two quick bilateral blinks, followed by a 250-750 millisecond pause, followed by another blink, all performed within one second. In yet another example, a facial gesture 114 may also incorporate relative movements of the mobile device and its imaging sensor with respect to the user's face; for example, the facial security gesture may consist simply of a frontal view of the user's face, followed in 0.5 seconds by moving of the camera closer to his face by 50%. The user 110 may be required to touch (either press-and-hold or press once) a button (either a physical button or a virtual button or icon on a touch screen) on the device before initiating image capture for static facial recognition and/or prior to performing a facial gesture 114.

According to another embodiment, a face recognition based payment authorization system may be incorporated into portable electronic devices (such as a laptop computer) and into relatively fixed electronic devices (such as a video game console or desktop computer system). Authorization to transmit protected payment information from the user's electronic device 102 to a merchant or financial institution may be accomplished through the internet using wired or wireless connectivity. For example, a user 110 may wish to make an in-game purchase while playing a video game; if an image 118 of the user 110 captured by a camera 104 associated with the gaming system matches that of a stored reference image 506 of the authorized user, then transmission of payment information or authorization for the transaction is transmitted to the seller. In another example, if a user is shopping at an online website on his home desktop computer, his purchases may be authorized if an image 118 of his face 112 captured contemporaneously by a camera 104 mounted on or within his computer or computer display screen 116 matches a stored reference image 506 and/or a designated security facial gesture 140.

In one embodiment, an electronic device 102 is in an initial secure state, wherein no protected data are transmitted. When the device is brought in proximity to and is interrogated by an external reader, the mobile device prompts the user 110 to capture an image 118 of his face 112 using the device's built-in camera. The captured image may be compared using facial recognition software with a stored reference image, which has been previously submitted by the user and stored on the mobile device. If the input facial image is sufficiently similar to the stored reference facial image, the mobile device transmits and/or allows to be transmitted, the requested information to the reader. If the captured image is sufficiently different to the previously stored reference image, then the mobile device is prevented from transmitting the requested information.

In one embodiment, following capture of an image of a user's face 112 and successful recognition of that face 112 by the mobile device, the target device may enter a state in which it then permits passive interrogation by an external reader and allows transmission of the requested information. The protected data may be transmitted once, after which the device reenters the secure state. In another implementation, the mobile device, once authorized, may enter a state in which it permits interrogation by an external reader and allows data transmission for only a limited time period (for example, 10 seconds) and/or for a limited number of events (for example, three interrogation attempts) before reentering the secure state, in which no information is permitted to be transmitted.

In one embodiment, the authorized user's reference images may be stored on a remote computer server 132. In another embodiment, the reference image or images of the authorized user may be stored locally in the mobile electronic device. In one example, when a user wishes to conduct a financial transaction with his bank using his mobile electronic device, he may capture a contemporaneous image 118 of his face 112. The image 118 (and/or an abbreviated data set consisting of relevant facial feature parameters, such as relative interpupillary distance, relative facial height versus width, etc.), may be transmitted to one of the bank's central computer servers, where the captured image (and/or abbreviated data set) is compared with one or more stored reference images (and/or abbreviated data sets). If the user 110 is recognized through facial recognition software, the user is permitted to access otherwise restricted websites, facilities, functions, data, and communications using his mobile electronic device, which may reside within the mobile electronic device or within one or more remote computer servers 132 in the cloud environment 130.

FIG. 1C illustrates an example of a facial gesture 114, according to one embodiment. The facial gesture 114 may be a dynamic facial gesture. The user 110 may wink the right eye and then the left eye over a period of time to create a dynamic facial gesture. In operation 142, both eyes are open. In operation 144, the right eye is closed. In operation 146, the left eye is closed. In operation 148, both eyes are open.

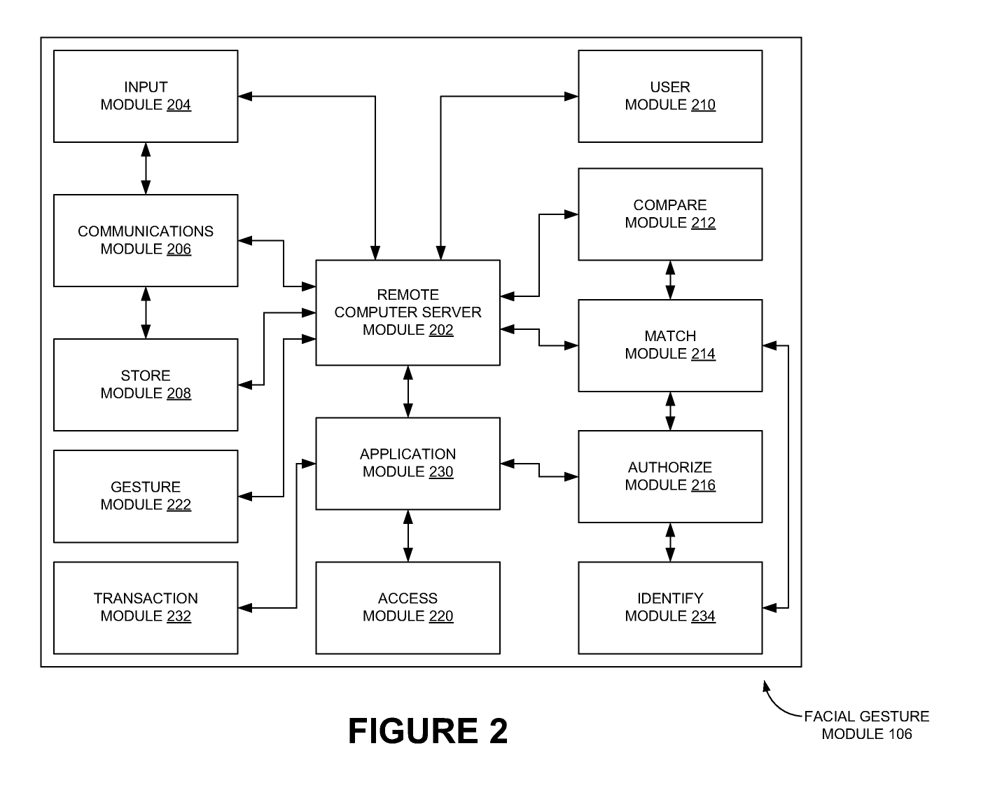

FIG. 2 is a block illustration of the contents of a facial gesture module 106 and processes that may occur within, according to one embodiment. Particularly, FIG. 2 illustrates an input module 204, a communications module 206, a store module 208, a gesture module 222, a remote computer server module 202, an application module 230, an access module 220, a user module 210, a compare module 212, a transaction module 232, a match module 214, an identify module 234, and an authorize module 216, according to one exemplary embodiment.

The input module 204 may accept an image 118 of the face 112, which may be captured through the camera 104 of the electronic device 102. The communications module 206 may communicate the image 118 of the face 112 to the store module 208, wherein the image 118 of the face 112 may be stored. The gesture module 222 may recognize the facial gesture 114 of the image 118 of the face 112 as a gesture to be compared with a user-defined facial gesture 120. The user module 210 may identify a user of the electronic device 102 based on the facial gesture 114 of an image 118 of the face 112. The compare module 212 may compare the image 118 of the face 112 and the designated security facial gesture 140 stored in the remote computer server 132. The match module 214 may determine a match between the image 118 of the face 112 to the designated security facial gesture 140 stored in the remote computer server 132. The authorize module 216 may grant authorization for the electronic device 102 to access an application 108 and/or data resources stored in the remote computer server 132 upon matching of the image 118 of the face 112 and the designated security facial gesture 140. The application module 230 permits an access of an application 108 through the electronic device 102 upon receiving an authorization from the remote computer server 132 and the access module 220 permits access to the application 108 and/or data resources stored in the remote computer server 132.

According to one embodiment, the gesture module 222 may enable the electronic device 102 to recognize the facial gesture 114 of the image 118 of the face 112 as a user-defined facial gesture 120. The facial gesture module 106 may be interfaced with the processor 702 to associate the image 118 of the face 112 with a designated security facial gesture 140. The user module 210 may create security facial gestures based on a user input.

The facial gesture 114 of the image 118 of the face 112 captured through the camera 104 may be determined to be the user-defined facial gesture 120. An image 118 of a facial gesture 114 used to access an application may be a user-defined facial gesture 120. User-defined facial gestures 120 may be a subset of human facial gestures. The user 110 may define a particular facial gesture for a particular purpose (for example, to access a certain application). For example, a wink may access an online banking application and a smile may access an email application. As an example, the user 110 may define a wink as the closing of one eye. The electronic device 102 in the initial state may be operated such that certain functions may be disabled in the initial state to conserve battery consumption of the electronic device 102 through a power management circuitry of the electronic device 102.

In one embodiment, the user 110 may create a user-defined facial gesture 120 and/or a designated security facial gesture 140. The user 110 may create a designated security facial gesture 140 to permit access to an application 108 and another designated security facial gesture to permit access to another application. If the designated security facial gesture 140 and the another designated security facial gesture are similar within a tolerance value, then the user 110 may be prompted to recreate the another designated security facial gesture.

In another embodiment, the user 110 may permit another user to access an application 108 of the user 110 based on a facial gesture 114 of the another user and/or another facial gesture of the another user. For example, a user 110 may permit another user (for example, a relative) to access an application 108 through the same facial gesture (for example, a smile) of the user 110 or the another user may create another facial gesture (for example, a wink) to access the application 108.

The application module 230 may communicate with the application 108. Once the user 110 of the electronic device 102 is authorized to access the application 108, the user 110 may be permitted to access the application 108 through the access module 220. A transaction (for example, a financial transaction and/or a personal data transaction) may be permitted through the transaction module 232. In one embodiment, the user 110 may be permitted to perform a transaction once the user 110 is permitted to access the application 108 through which the transaction may take place. In another embodiment, the user 110 may be required to re-enter an image 118 of the face 112 to confirm the transaction. The identify module 234 may identify the user 110 of the electronic device 102.

In another embodiment, access to the application 108 may be verified though a facial recognition of the user 110. The camera 104 of the electronic device 102 may capture an image of the user 104 of the electronic device 102. The image 118 of the user 110 may be authenticated against another image 118 of the user 110. Access of the application 108 may include the facial recognition as an additional security feature to the facial gesture 114. The image 118 of the face 112 of the user of the electronic device 102 may be compared with a reference image of the user 110. The access of the application 108 of the electronic device 102 may be permitted when the facial gesture 114 of the image 118 of the face 112 of the user 110 of the electronic device 102 matches the designated security facial gesture 140 and when the image 118 of the face 112 of the user matches the reference image of the user 110. The remote computer server module 202 may interact with the remote computer server 132.

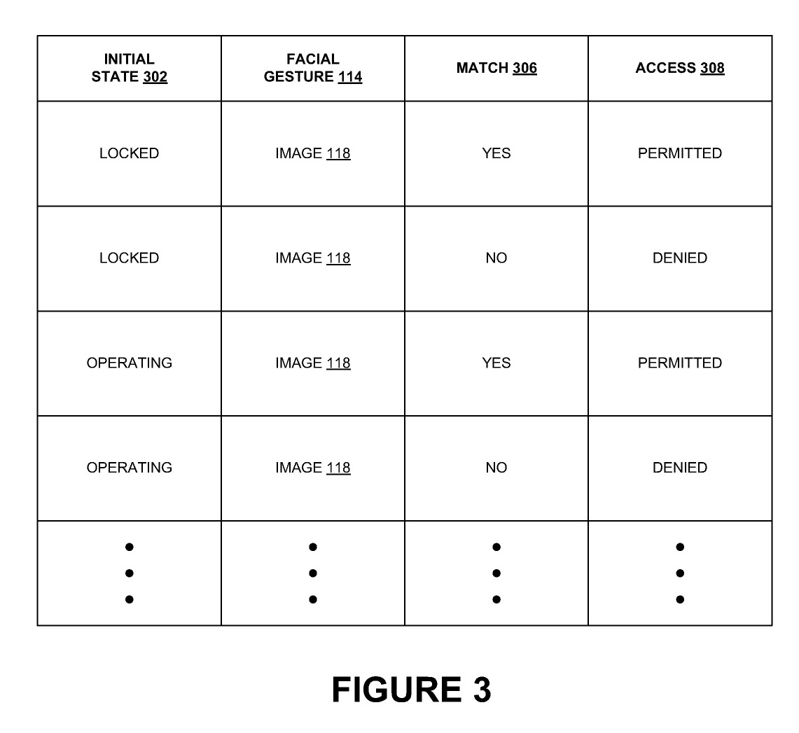

FIG. 3 is a table view illustrating various fields such as an initial state 302, a facial gesture 114, match 306, and access 308, according to one embodiment. In an example embodiment, the initial state 302 of electronic device 102 may be in a locked state or an operating state. Access of an application 108 may permit the user 110 to transform the electronic device 102 from a locked state to an operating state.

The field for facial gesture 114 may include an image 118 of the face 112 of the user 110. The field for match 306 may include the determination of a comparison between the facial gesture 114 of the image 118 of the face 112 of the user 110 and the designated security facial gesture 140. The field for access 308 may include the result of the determination of the match 306. For example, access 308 of an application 108 may be permitted or denied.

According to an exemplary embodiment, if the initial state 302 is operating and the input facial gesture 114 is the image 118 of the face 112 and the image 118 of the face 112 matches the stored designated facial gesture 140, access 308 may be granted which may result in the electronic device 102 being able to access an application 108, data and/or resources stored on a remote computer server 132. According to another exemplary embodiment, if the initial state 302 is operating and the input facial gesture 114 is the image 118 of the face 112 and the image 118 of the face 112 is different than the stored designated facial gesture 140, access 308 may be denied and the electronic device 102 may be restricted and/or prevented from accessing an application 108, data and/or resources stored on a remote computer server 132.

In another embodiment, the user 110 may capture an image 118 of his face 112 prior to and in anticipation of interrogation by an external reader. If the user's face 112 is properly recognized as an authorized user of the device by positive comparison with a stored reference image, then the device may be transformed into a state in which transmission of information requested by an interrogating external reader is permitted under certain conditions, for example, if an external query is received by the mobile device within a finite time period (for example, 30 seconds) from the time the user's face is recognized. If no query or one successful query by an initiator device is received by the target device within this time-out period, the device may then reenter a secure state, in which no secure information is permitted to be transmitted without reauthorization. For example, in this implementation, a user may capture an image of his face while approaching the RFID (Radio Frequency Identification) reader of a locked door or subway turnstile.

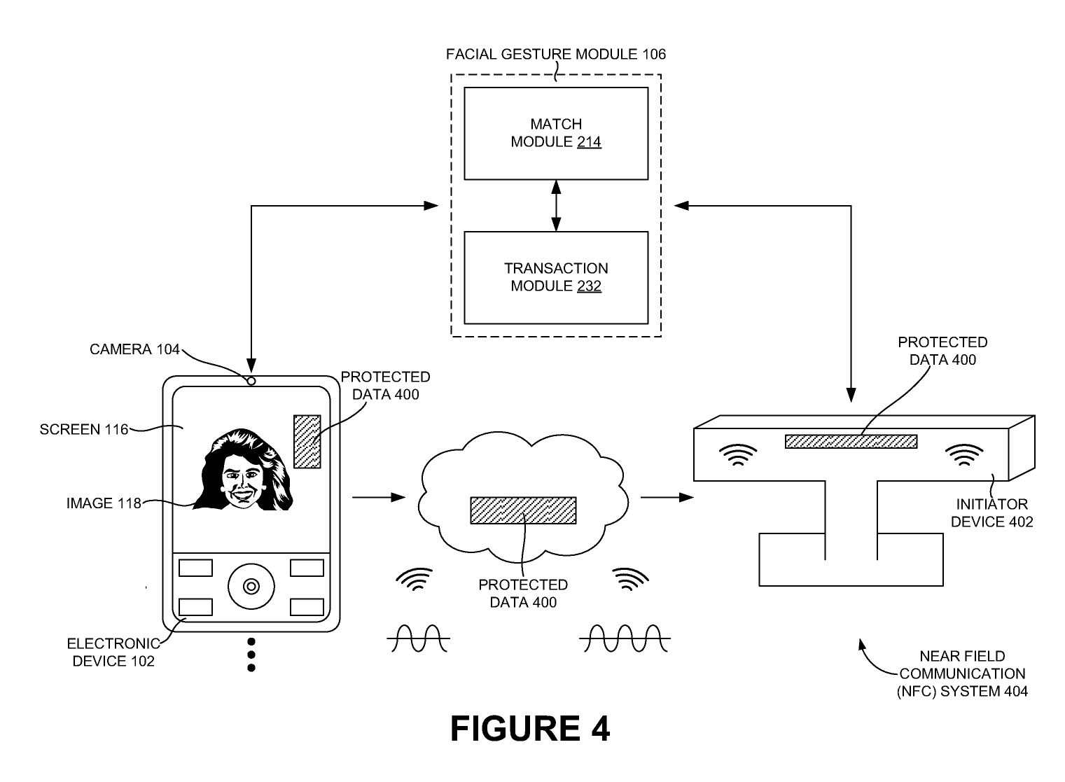

FIG. 4 illustrates a schematic view of the matching of the image 118 of the user 110 and the designated security facial gesture 140 to permit transmission of the protected data 400, according to one embodiment. In an example embodiment, the transmission may be through NFC (Near Field Communication) system. The match module 214 and the transaction module 232 of the facial gesture module 106 may wirelessly transmit the protected data 400 (for example, payment data) to the initiator device 402. The initiator device 402 may be a device that accepts protected data 400 (for example, payment data associated with a credit/debit card).

A user 110 may capture an image 118 of the face 112 using a camera 104 of the electronic device 102 (for example, a mobile phone). According to one embodiment, the image 118 of the face 112 may then be stored locally within the electronic device 102 as a user-defined facial gesture 120. Subsequently, and according to one embodiment, if a user-defined facial gesture 120 matches the designated security facial gesture 140, the protected data 400 is wirelessly transmitted to the initiator device 402, according to one embodiment.

According to one embodiment, the disclosure may employ a passive communication mode. In this mode, the initiator device 402 may provide a carrier field and the electronic device 102 may answer by modulating the existing field and may draw its operating power from the initiator-provided electromagnetic field, thus making the electronic device 102 a transponder. According to another embodiment, the disclosure may employ an active communication mode where both the initiator device 402 and the electronic device 102 may communicate by alternately generating their own fields. One device (either the electronic device 102 or the initiator device 402) may deactivate its RF (Radio Frequency) field while it waits for data (for example, protected data 400). In this mode, both devices may have their own power supplies. In another embodiment, the target device may operate in a battery-assisted passive mode.

The initiator device 402 and the electronic device 102 may employ two or more different types of coding to transfer data (for example, the protected data 400), according to one or more embodiments. If an active device (for example, electronic device 102) transfers the protected payment data 400 at 160 Kbit/s, a modified Miller coding with 100% modulation may be used. In other cases, according to other embodiments, Manchester coding may be used with a modulation ratio of 10%. It may also be that some target devices and initiator devices (such as electronic device 102 and initiator device 402) may not be able to receive and transmit the protected payment data 400 at the same time. Thus, these devices may check the RF field and may detect a collision if the received signal matches the transmitted signal's modulated frequency band, according to one or more embodiments.

The electronic device 102 may be a mobile phone or a mobile electronic device capable of sending and receiving data, according to one embodiment. There may be several uses for NFC technology employed in the disclosure (according to the NFC Forum) according to at least three exemplary embodiments. The first method may employ a reader/writer mode wherein the initiator device 402 may be active and may read a passive RFID tag (for example, a smart poster, a smart card, an RFID tag implanted within a electronic device 102 etc.). The second method may employ a P2P mode wherein the electronic device 102 and the initiator device 402 may exchange data (for example, virtual business cards, digital photos, protected payment data 400 etc.). Lastly, the third method may employ a card emulation mode wherein the electronic device 102 and the initiator device 402 may behave like an existing contactless card and may be used with existing technology infrastructures according to one or more embodiments.

In one embodiment, a mobile electronic device equipped with NFC capabilities and a digital camera is permitted to wirelessly transmit protected payment information (such as a bank account number or credit card number and PIN) to an initiator device (such as an electronic payment terminal) in response to interrogation by an initiator device, if a contemporaneous captured digital image of the user's face 112 matches a stored reference image of the authorized user.

In an example situation incorporating the disclosure, a person approaches a touchless pay terminal at, for example, a grocery store. The user takes a picture of himself with a camera built in to his phone. The captured image is analyzed using facial recognition technology and, if the image matches a stored reference photo of that person, the device enters a state in which it is permitted to wirelessly transmit protected payment data (such as a credit card number and PIN) when the user then holds the device in proximity to the pay terminal for interrogation through the NFC reader. The mobile device may be authenticating the user's identity at the same time that the user is looking at the display screen to conduct a transaction.

In another embodiment, the protected data 400 transmitted by the target electronic mobile device may be one of a plurality of protected payment data, personal identification information, and an authorized access code. In one example, if a contemporaneous image of a user's face 112 matches a stored reference image of an authorized user's face 112, then the electronic device 102 may wirelessly transmit an authorization code when interrogated by an initiator device 402 which grants access to an otherwise restricted facility, such as a locked building, gate, garage, or turnstile. According to this embodiment, the facial recognition-equipped and NFC-capable electronic device may act as a master electronic pass key device affording access to any number of locked facilities. While a passive NFC-equipped pass card might allow access to some facilities to an unauthorized bearer who has stolen or otherwise misappropriated it, a facial recognition-protected electronic key may provide additional security.

Once a user's identity is authenticated (for example, through a static or video-assisted facial recognition), the electronic device 102 may be set to remain in a state permitting wireless transmission of otherwise protected data 400 when interrogated by an external reader or if manually initiated by the user for a period of time and under conditions that may be defined by the user under a set of user preferences. According to one or more embodiments, a user 110 may be required to periodically re-verify his identity by looking at his phone (for example, once a day, every hour, or prior to transmission of certain sensitive information, such as protected payment data wirelessly transmitted via NFC to a touchless merchant payment terminal), according to a set of parameters which may be defined by the user 110. A remote computer server 132 may send a signal to the electronic device 102 to revoke such blanket permission and disable transmission of sensitive data by the device, if it is reported lost or stolen by its authorized user.

The protected data 400 transmitted wirelessly through the electronic device 102 in response to interrogation by the initiator device 402, if a contemporaneously captured image of the user's face 112 matches a reference image, may be secure personal data, such as protected payment data (such as a credit card number), a security clearance code (such as for entry into a restricted area), or personal identity data (such as a passport number).

The described capability may reside in a device dedicated to govern authorization of wireless transmission of sensitive information (such as a credit card-sized device featuring a built-in camera), or may be included as a part or feature of another mobile electronic device (such as a mobile phone, media player, or tablet computer).

The external interrogating device, or initiator device 402, may, for example, be a reader for a contactless payment system (such as a merchant pay terminal, parking meter, or vending machine), a card reader governing access to a restricted area (such as a secured building or garage), or a system for restricting access to ticketed customers (such as a transit system, theater, or stadium).

The initiator device 402 also may itself be another electronic device 102. For example, an associate may request that a user transfer her contact information (or electronic business card) from her cellular phone to his tablet computer using an information exchange application. In such an implementation, her device would permit transmission of the requested data following authentication of her identity through recognition of a contemporaneously captured facial image.

The wireless transmission of the protected data 400 from the electronic device 102 to the initiator device 402 may occur through radio frequency emission (such as according to NFC protocols) or through an encoded signal within another regime of the electromagnetic spectrum. In one embodiment, the wireless data transmission may occur via modulation of an encoded visible or infrared light signal. In this implementation, when a contemporaneous image of a user face is recognized in response to or in anticipation of interrogation by an initiator device, a spatially encoded optical pattern containing requested protected data 400 may be emitted by the electronic device 102. Such an optical pattern may be in the form of a one or two dimensional barcode depicted on the display screen of the target device, which may then be read by an optical scanner of the initiator device 402, according to one embodiment.

In another embodiment, the protected payment data 400 may be transmitted as a temporally encoded pulse stream by a light emitter (for example, by a light-emitting diode, or LED, operating in the infrared spectrum) of the electronic device 102, which may be detected by the initiator device 402 by means of an optical sensor. This optical-based wireless transmission of protected payment information may substitute or augment simultaneous transmission of protected data via NFC radiofrequency modulation.

According to one or more embodiments, the air interface for NFC may be standardized in the ISO/IEC 18092/ECMA-340 “Near Field Communication Interface and Protocol-1” (NFCIP-1) or in the ISO/IEC 21481/ECMA-352 “Near Field Communication Interface and Protocol-2” (NFCIP-2). The initiator device 402 and the electronic device 102 may incorporate a variety of existing standards including ISO/IEC 14443, both Type A and Type B, and FeliCa. According to another embodiment, a common data format called NFC Data Exchange Format (NDEF) may be used to store and transport various kinds of items, including any MIME-typed object, ultra-short RTD-documents (for example, URLs), and the protected payment data 400.

An NFC-enabled electronic device 102 and initiator device 402 may be used to configure and initiate other wireless network connections such as Bluetooth, Wi-Fi or Ultra-wideband. The NFC technology described in the above embodiments may be an open platform technology standardized in ECMA-340 and ISO/IEC 18092. These standards may specify the modulation schemes, coding, transfer speeds and frame format of RF interfaces of NFC devices (for example, the electronic device 102 and the initiator device 402), as well as initialization schemes and conditions required for data (for example, the protected payment data 400) collision-control during initialization for both passive and active NFC modes, according to one embodiment. Furthermore, they may also define the transport protocol, including protocol activation and data-exchange modes.

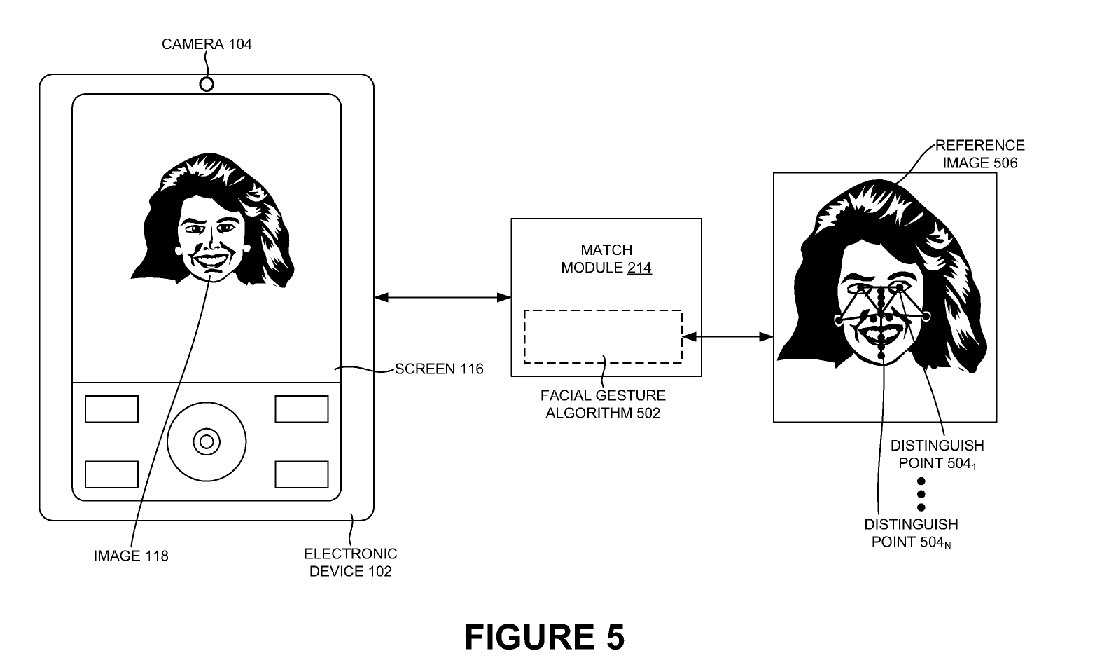

FIG. 5 illustrates a system view of a processing of an image 118 of a face 112 of a user 110 through a facial gesture algorithm 502, according to one embodiment. The image 118 of the face 112 may be processed through the facial gesture algorithm 502 of the match module 214 to determine if the facial gesture 114 matches the designated security facial gesture 140. The facial gesture algorithm 502 may use various distinguish points 504 of the face 112 to determine a match. The facial gesture algorithm 502 may determine a match between the facial gesture 114 and the designated security facial gesture 140 and/or between the image 118 of the face 112 and the reference image of the face. For example, the facial gesture algorithm 502 may measure the distance between the eyes and the nose. The reference image 506 may be an image of the face 112 of the user 110.

Video may also be employed by the mobile device to aid or implement facial recognition of the user, according to another embodiment. For example, the user may be required to turn his head from side to side while the mobile device captures imagery of his face 112. The relative rotation of the user's head with respect to the fixed image sensor may provide three-dimensional information about the user's unique facial features. Such facial features may include the relative distance between a line connecting a user's pupils, the line connecting the tops of his ears, and the relative spatial relationship of the tip of his nose with respect to a plane defined by the tips of his earlobes and chin.

In another embodiment, facial recognition of the user 110 by the mobile electronic device may be implemented by simultaneous use of more than one image sensor of the device. For example, the device may contain two separate cameras, which, owing to their different locations in space with respect to the user 110, may provide stereoscopic depth information about the user's facial features (for example, the relative anterior-to-posterior distance from the tip of a user's nose with respect to his ears). The image 118 may be a three dimensional image and/or comprise stereoscopic depth information.

In another embodiment, the contemporaneously captured user images and the stored reference images may be in various spectral regimes. For example, the image 118 may be a conventional color or black-and-white photograph. In another example, the images may be recorded in the infrared portion of the light spectrum. Operating in the infrared regime may provide different information. For example, a conventional photograph of a user, either printed on paper or rendered on an electronic display screen, held up to the camera of a portable electronic device would be different, because the photograph lacks the corresponding active heat signature that would be detected at infrared wavelengths. Infrared images may provide a different signal-to-noise ratio for facial feature detection. For example, a user wearing a veil or burka may obscure facial features in the visible spectrum. Infrared images may provide the ability to detect different discriminating features (such as a subcutaneous chin implant) that would be inconspicuous at visible wavelengths.

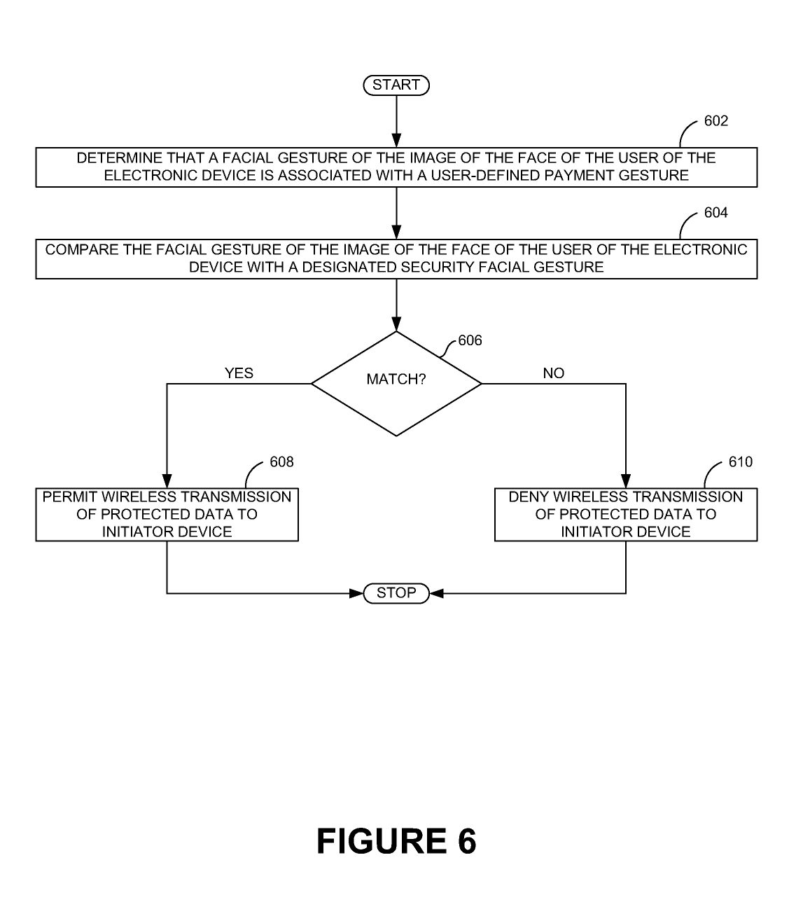

FIG. 6 is a flow chart illustrating accepting and comparing an image 118 of a facial gesture 114 to access an application 108 of the electronic device 102, according to one embodiment. In operation 602, the system determines that the facial gesture 114 of the image 118 of the face 112 of the user 110 of the electronic device 102 is associated with a user-defined facial gesture 120. In operation 604, the facial gesture 114 of the image 118 of the face 112 of the user 110 of the electronic device 102 is compared with a designated security facial gesture 140.

In operation 606, the system determines if there is a match between the facial gesture 114 of the image 118 of the face 112 of the user 110 of the electronic device 102 and the designated security facial gesture 140. In operation 608, the system permits a wireless transmission of protected data 400 to the initiator device 402, if there is a match. In operation 610, the system denies a wireless transmission of protected data 400 to the initiator device 402, if there is no match.

In one embodiment, if the captured image of the user's face is not successfully matched with a stored reference image, the target device is not permitted to transmit the requested protected data 400 in response to interrogation by an initiator device 402. In one embodiment, the target device may require the user to enter some alternate form of authentication prior to permitting transmission of the protected information and/or access of an application 108. Examples of some alternate form of authentication may include a capture of another facial image taken in a different projection (such as left oblique or right profile), an alternative gesture (such as one with left eye closed), a capture of another image taken under different conditions (such as more frontal light, less backlight, or hat or glasses removed), an entry of an alphanumeric password on a physical or virtual keyboard of the device, an entry of a user-defined security gesture above a touch-receptive input area of the device, and a submission of another type of biometric identification (such as a fingerprint scan or voiceprint analysis).

It will be recognized that a user face recognition based system for payment authorization may be combined with other methods of user authentication, such as other forms of biometric identification (for example, fingerprint, iris, or retinal scanning) or entry of some form of password (for example, a user-defined authorization gesture or entry on a keyboard or virtual keyboard of an alphanumeric password or code).

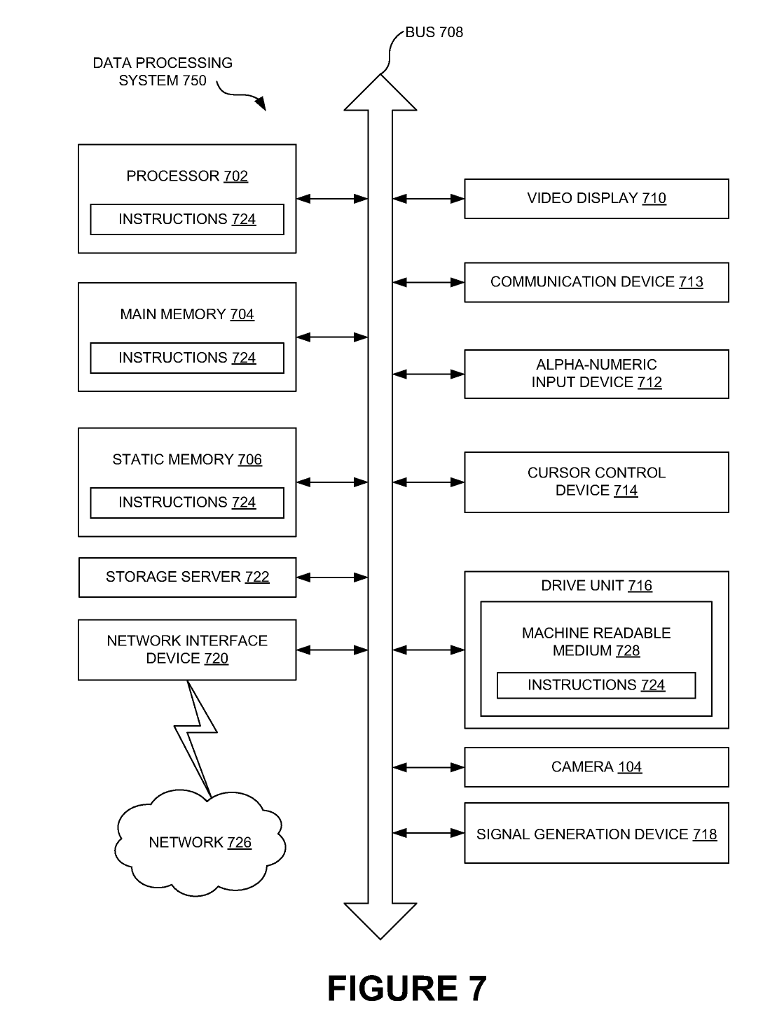

FIG. 7 may indicate a personal computer, electronic device, mobile device and/or the data processing system 750 in which one or more operations disclosed herein may be performed. The facial gesture module 106 may provide security to the device from unauthorized access (if it is mishandled, misused, stolen, etc.). The processor 702 may be a microprocessor, a state machine, an application specific integrated circuit, a field programmable gate array, etc. (for example, Intel® Pentium® processor, 620 MHz ARM 1176®, etc.). The main memory 704 may be a dynamic random access memory and/or a primary memory of a computer system.

The static memory 706 may be a hard drive, a flash drive, and/or other memory information associated with the data processing system 750. The bus 708 may be an interconnection between various circuits and/or structures of the data processing system 750. The video display 710 may provide graphical representation of information on the data processing system 750. The alpha-numeric input device 712 may be a keypad, a keyboard, a virtual keypad of a touchscreen and/or any other input device of text (for example, a special device to aid the physically handicapped). The camera 104 may capture an image 118 of the user 110.

The cursor control device 714 may be a pointing device such as a mouse. The drive unit 716 may be the hard drive, a storage system, and/or other longer term storage subsystem. The signal generation device 718 may be a bios and/or a functional operating system of the data processing system 750. The network interface device 720 may be a device that performs interface functions such as code conversion, protocol conversion and/or buffering required for communication to and from a network 726. The machine readable medium 728 may be within a drive unit 716 and may provide instructions on which any of the methods disclosed herein may be performed. The communication device 713 may communicate with the user 110 of the data processing system 750. The storage server 722 may store data. The instructions 724 may provide source code and/or data code to the processor 702 to enable any one or more operations disclosed herein.

The modules of the figures may be enabled using software and/or using transistors, logic gates, and electrical circuits (for example, application specific integrated ASIC circuitry) such as a security circuit, a recognition circuit, an association circuit, a store circuit, a transform circuit, an initial state circuit, an unlock circuit, a deny circuit, a permit circuit, a user circuit, and other circuits.

Although the present embodiments have been described with reference to specific example embodiments, it will be evident that various modifications and changes may be made to these embodiments without departing from the broader spirit and scope of the various embodiments. For example, the various devices, modules, analyzers, generators, etc. described herein may be enabled and operated using hardware circuitry (for example, CMOS based logic circuitry), firmware, software and/or any combination of hardware, firmware, and/or software (for example, embodied in a machine readable medium). For example, the various electrical structure and methods may be embodied using transistors, logic gates, and electrical circuits (for example, ASIC and/or in Digital Signal Processor (DSP) circuitry).

In addition, it will be appreciated that the various operations, processes, and methods disclosed herein may be embodied in a machine-readable medium and/or a machine accessible medium compatible with a data processing system (for example, a computer system), and may be performed in any order (for example, including using means for achieving the various operations). Accordingly, the specification and drawings are to be regarded in an illustrative rather than a restrictive sense.

What is claimed is:

1. A method of an electronic device comprising:
capturing an image of a face a user through a camera of the electronic device such that an application of the electronic device is accessible through the electronic device based on the image of the face of the user, wherein the image of the face of the user comprises a facial gesture of the user;
determining through a processor that the facial gesture of the image of the face of the user of the electronic device is associated with a user-defined facial gesture;
comparing the facial gesture of the image of the face of the user of the electronic device with a designated security facial gesture; and
permitting an access of the application of the electronic device when the facial gesture of the image of the face of the user of the electronic device matches the designated security facial gesture.

2. The method of claim 1 wherein the electronic device is a mobile device.

3. The method of claim 2 further comprising restricting the access of the application of the electronic device when the facial gesture of the image of the face of the user of the electronic device is different than the designated security facial gesture.

4. The method of claim 3 further comprising permitting an identification of the user through the electronic device when the facial gesture of the image of the face of the user of the electronic device matches the designated security facial gesture.

5. The method of claim 4 further comprising permitting an authentication of the user through the electronic device when the facial gesture of the image of the face of the user of the electronic device matches the designated security facial gesture.

6. The method of claim 5 further comprising permitting a transaction of the user through the electronic device when the facial gesture of the image of the face of the user of the electronic device matches the designated security facial gesture.

7. The method of claim 6 further comprising permitting a financial transaction of the user through the electronic device and an initiator device through a Near Field Communication (NFC) system when the facial gesture of the image of the face of the user of the electronic device matches the designated security facial gesture.

8. The method of claim 7 further comprising comparing the image of the face of the user of the electronic device with a reference image of the user.

9. The method of claim 8 further comprising permitting the access of the application of the electronic device when the facial gesture of the image of the face of the user of the electronic device matches the designated security facial gesture and when the image of the face of the user matches the reference image of the user.

10. A method of a server device comprising:
determining through a processor that a facial gesture of an image of a face of a user of an electronic device is associated with a user-defined facial gesture;
comparing the facial gesture of the image of the face of the user of the electronic device with a designated security facial gesture; and
permitting an access of an application of the electronic device when the facial gesture of the image of the face of the user of the electronic device matches the designated security facial gesture.

11. The method of claim 10 wherein the electronic device is a mobile device.

12. The method of claim 11 further comprising restricting the access of the application of the electronic device when the facial gesture of the image of the face of the user of the electronic device is different than the designated security facial gesture.

13. The method of claim 12 further comprising permitting a transaction of the user through the electronic device when the facial gesture of the image of the face of the user of the electronic device matches the designated security facial gesture.

14. The method of claim 13 further comprising permitting a financial transaction of the user through the electronic device and an initiator device through a Near Field Communication (NFC) system when the facial gesture of the image of the face of the user of the electronic device matches the designated security facial gesture.

15. The method of claim 14 further comprising comparing the image of the face of the user of the electronic device with a reference image of the user.

16. The method of claim 15 further comprising permitting the access of the application of the electronic device when the facial gesture of the image of the face of the user of the electronic device matches the designated security facial gesture and when the image of the face of the user matches the reference image of the user.

17. A method of an electronic device comprising:
capturing an image of a face a user through a camera of the electronic device such that an application of the electronic device is accessible through the electronic device based on the image of the face of the user;
comparing through a processor the image of the face of the user of the electronic device with a reference image of the user; and
permitting an access of the application of the electronic device when the image of the face of the user of the electronic device matches the reference image of the user.

18. The method of claim 17 wherein the electronic device is a mobile device.

19. The method of claim 18 further comprising restricting the access of the application of the electronic device when the image of the face of the user of the electronic device is different than the reference image of the user.

20. The method of claim 19 further comprising permitting the financial transaction of the user through the electronic device and an initiator device through a Near Field Communication (NFC) system when the image of the face of the user of the electronic device matches the reference image of the user.
